(19) United States
(12) Patent Application Publication
(10) Pub. No.: US 2022/0146212 A1
(43) Pub. Date: May 12, 2022

(54) COOLING TUBES, SYSTEMS, AND METHODS

(71) Applicant: Aperta Motors, Corp., San Diego, CA (US)

(72) Inventors: Chris ANTHONY, San Diego, CA (US); Steve FAMBRO, Carlsbad, CA (US)

(73) Assignee: Aptera Motors, Corp., San Diego, CA (US)

(21) Appl. No.: 17/454,105

(22) Filed: Nov. 9, 2021

Related U.S. Application Data
(60) Provisional application No. 63/111,109, filed on Nov. 9, 2020.

(51) Int. Cl. F28F 1/04; F28F 21/08; B60K 11/04

(52) U.S. Cl. CPC F28F 1/04; F28F 2245/06; B60K 11/04; F28F 21/084

(57) ABSTRACT

Radiators, automobiles, and methods of transferring thermal energy to or from an automobile. The radiators include elongated, flattened tubes that transfer thermal energy while minimally affecting the reference area of the automobile, reducing the amount of drag produced by the radiator.

### CROSS-REFERENCE TO RELATED APPLICATIONS

This application claims priority to U.S. Provisional Patent Application No. 63/111,109, filed Nov. 9, 2020, which is incorporated by reference herein in its entirety.

### FIELD OF THE DISCLOSURE

This disclosure relates generally to cooling tubes, cooling systems, and methods of cooling and, in particular, relates to cooling tubes, cooling systems, and methods of cooling automobiles.

### BACKGROUND

Automobiles generate heat when in use, either through the use of an internal combustion engine or another power generation means such as batteries and electric motors. In order to dissipate heat, automobiles are typically equipped with a radiator positioned in such a way that air passes through an array of fins.

Prior automobiles equipped with a radiator position the radiator at the front of the automobile and protect it with a grille. In some automobiles, the radiator is positioned proximal to an engine in the middle of the automobile, with air scoops capturing passing air and forcing it through the radiator. These radiators create a tremendous amount of drag, reducing the efficiency of the automobile's fuel and/or engine.

Accordingly, improved radiators are needed, as well as methods for manufacturing them, for overcoming one or more of the technical challenges described above.

### BRIEF DESCRIPTION OF THE DRAWINGS

The detailed description is set forth with reference to the accompanying drawings. The use of the same reference numerals may indicate similar to identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 is a perspective view of a radiator in accordance with the present disclosure.

FIG. 2A is a side schematic view of an elongated, flattened tube in accordance with the present disclosure.

FIG. 2B is an upper schematic view of the elongated, flattened tube of FIG. 2A in accordance with the present disclosure.

FIG. 2C is a perspective view of an elongated, flattened tube in accordance with the present disclosure.

FIG. 3 is a perspective cross-sectional view of an elongated, flattened tube in accordance with the present disclosure.

FIG. 4 is a perspective view of a flattened tube in accordance with the present disclosure.

FIG. 5A is a perspective view of an automobile in accordance with the present disclosure.

FIG. 5B is a lower view of the automobile of FIG. 5A in accordance with the present disclosure.

FIG. 6 is a side view of an automobile in accordance with the present disclosure.

### DETAILED DESCRIPTION

Radiators, automobiles, and methods of transferring thermal energy to or from an automobile are provided herein including radiators, automobiles, and methods of transferring thermal energy that advantageously reduce or eliminate drag when the automobile is in motion, increase the possible positions on the automobile that can be equipped with a radiator, increase the ability for the radiator to dispel heat when the automobile is stationary, and add the ability for the radiator to transmit thermal energy from the surroundings into the automobile. The present disclosure includes non-limiting embodiments of radiators. The embodiments are described in details herein to enable one of ordinary skill in the art to practice the radiators, automobiles, and methods of transferring thermal energy to or from an automobile, although it is to be understood that other embodiments may be utilized and that logical changes may be made without departing from the scope of the disclosure.

Throughout this disclosure, various aspects are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6, etc., as well as individual numbers within that range, for example, 1, 2, 3, 4, 5, and 6. This applies regardless of the breadth of the range.

Radiators have been produced, each having one or more elongated flattened tubes with a first side configured to absorb thermal energy and a second side configured to dissipate thermal energy. Each flattened tube has one or more fluidic channels filled with a thermal transfer fluid, with each fluidic channel positioned proximal to each of the first and second sides. By forming the radiator out of elongated flattened tubes, each with fluidic channels filled with thermal transfer fluid, the radiator may be positioned on any surface of an automobile with minimal or no increase in the automobile's reference area, while maintaining a large thermal transfer area.

Radiators for Transferring Thermal Energy

Radiators for transferring thermal energy are disclosed herein. In some embodiments, the radiator includes one or more elongated, flattened tubes. The elongated, flattened tubes may include a first surface configured to absorb thermal energy, a second surface configured dissipate thermal energy, and/or one or more fluidic channels disposed between the first surface and the seconds surface. In some embodiments, each of the one or more fluidic channels is positioned proximal to the first surface of the tube and the second surface of the tube.

As used herein, “elongated” refers to having a high length:width ratio, where the length of the elongated, flattened tube is measured along a longitudinal axis and the width is measured perpendicular to the longitudinal axis and parallel to the first and second surfaces. In some embodiments, the elongated, flattened tubes have a length:width ratio of 20:1. In other embodiments, the length:width ratio is 15:1. The length:width ratio of the elongated, flattened tubes may be 5:1, 10:1, 15:1, 20:1, 25:1, 30:1, 35:1, 40:1, 45:1, 50:1, 55:1, 60:1, or any ratio therebetween.

As used herein, “flattened” refers to having a cross-sectional shape with a high width:height ratio, where the height is measured perpendicular to the longitudinal axis and perpendicular to the first and second surfaces. In some embodiments, the elongated, flattened tubes have a width:height ratio of 30:1. In other embodiments, the width:height ratio is 15:1. The width:height ratio of the elongated, flattened tubes may be 5:1, 10:1, 15:1, 20:1, 25:1, 30:1, 35:1, 40:1, 45:1, 50:1, 55:1, 60:1, or any ratio therebetween.

The use of relational terms, such as, but not limited to, “top,” “bottom,” “left,” “right,” “front,” “back,” and the like are used in the written description for clarity in specific reference to the Figures, or to refer to the relative disposition of portions of the radiator, and are not intended to further limit the scope of the invention or the appended claims. For example, an element described as “right” or “left” does not necessarily have to be to an observer's right or left. Instead, such terminology is intended to illustrate the relative portions of the radiator when used with corresponding other terminology. Any relative positioning in three-dimensional space of the elements of the radiator is contemplated.

As used herein, elements are described as “proximal” to one another if they are two neighboring elements capable of thermal exchange with only material of construction disposed therebetween. For example, a fluidic channel may be “proximal” to a first surface if a thermal transfer fluid within the channel accepts thermal energy transferred through the material of construction, such as aluminum, from the first surface. In other words, the presence of this material of construction is contemplated in the description of two elements being “proximal” to one another.

In some embodiments, each tube in the one or more elongated, flattened tubes includes a fluidic inlet positioned at a first end of the tube, a fluidic outlet positioned at a second end of the tube, and/or a thermal transfer fluid disposed within the one or more fluidic channels. The thermal transfer fluid may enter the one or more fluidic channels through the fluidic inlet. The thermal transfer fluid may exit the one or more fluidic channels through the fluidic outlet. In some embodiments, the thermal transfer fluid is configured to absorb thermal energy absorbed by the first surface and transfer the thermal energy to the second surface. In some embodiments, the thermal transfer fluid is configured to absorb thermal energy from a thermal generating component in an automobile and transfer that thermal energy, by first passing through the fluidic inlet into the one or more fluidic channels, to the second surface of the tube.

In some embodiments, the thermal transfer fluid is at least one of water, ethylene glycol, refrigerant, a combination thereof, or another suitable thermal transfer fluid known in the art.

In some embodiments, each of the one or more fluidic channels is substantially rectangular. As used herein, “substantially rectangular” refers to a shape having four sides and four corners. The corners may be rounded so that the shape approximates an oval, and the sides may be linear or curved.

In some embodiments, the second surface of each tube in the one or more elongated, flattened tubes includes a surface finish that may be configured to radiate thermal energy. The surface finish may have an emissivity of around 0.95.

As used herein, “emissivity” refers to an object's ability to emit infrared energy. Emissivity is the ratio of the radiant exitance of a surface, a property dependent on the material, and the radiant exitance of a black body at the same temperature as the surface. Therefore, the emissivity is a unitless value between 0 and 1, where an emissivity of 0 is approximated by a perfect mirror, and an emissivity of 1 is a perfect black body. In some embodiments, the surface finish has an emissivity of around 0.95. In some embodiments, the surface finish has an emissivity of around 0.85. The emissivity of the surface finish may be 0.7, 0.75, 0.8, 0.85, 0.9, 0.95, 0.975, 0.985, or any emissivity therebetween.

In some embodiments, the radiator is configured to be positioned on an external surface of an automobile. The radiator may be configured to transfer thermal energy between the automobile and external air. In some embodiments, the radiator is configured to transfer thermal energy from the automobile. In other embodiments, the radiator is configured to transfer thermal energy to the automobile, for example to supplement an electric vehicle's heater.

In some embodiments, each tube in the one or more elongated, flattened tubes has a small cross-section perpendicular to a longitudinal axis such that the radiator is configured to produce less drag than a conventional automobile radiator. The radiator may have minimal or no effect on the automobile's reference area.

As used herein, a “reference area” refers to the approximated area of an object that is used when calculating the object's drag coefficient. Thus, a radiator having minimal or no effect on the automobile's reference area refers to the radiator having minimal or no effect on the drag produced by the automobile.

In some embodiments, the one or more elongated, flattened tubes includes aluminum. In other embodiments, the tubes include one or more of aluminum, copper, brass. Any suitable material for transferring thermal energy may be used in constructing the one or more elongated, flattened tubes.

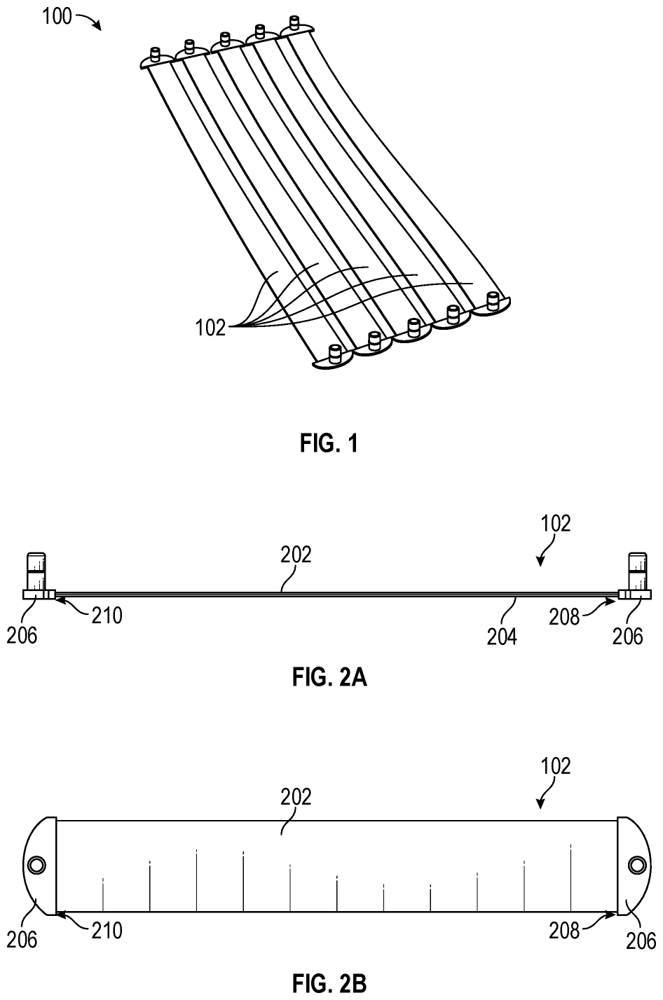

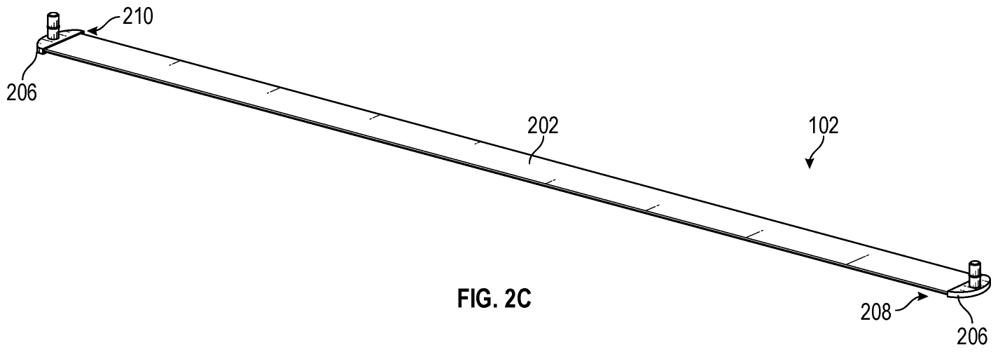

FIG. 1 is a perspective view of a radiator 100 including one or more elongated, flattened tubes 102. FIGS. 2A, 2B, and 2C depict an elongated, flattened tube 102 having a first surface 202 configured to absorb thermal energy and a second surface 204 configured to dissipate thermal energy. Each elongated, flattened tube 102 includes fluidic inlets 206 positioned at a first end 208 and a second end 210 of the tube 102. Each fluidic inlet 206 is configured to operate as an inlet or an outlet, depending on the flow of thermal transfer fluid through the elongated, flattened tube.

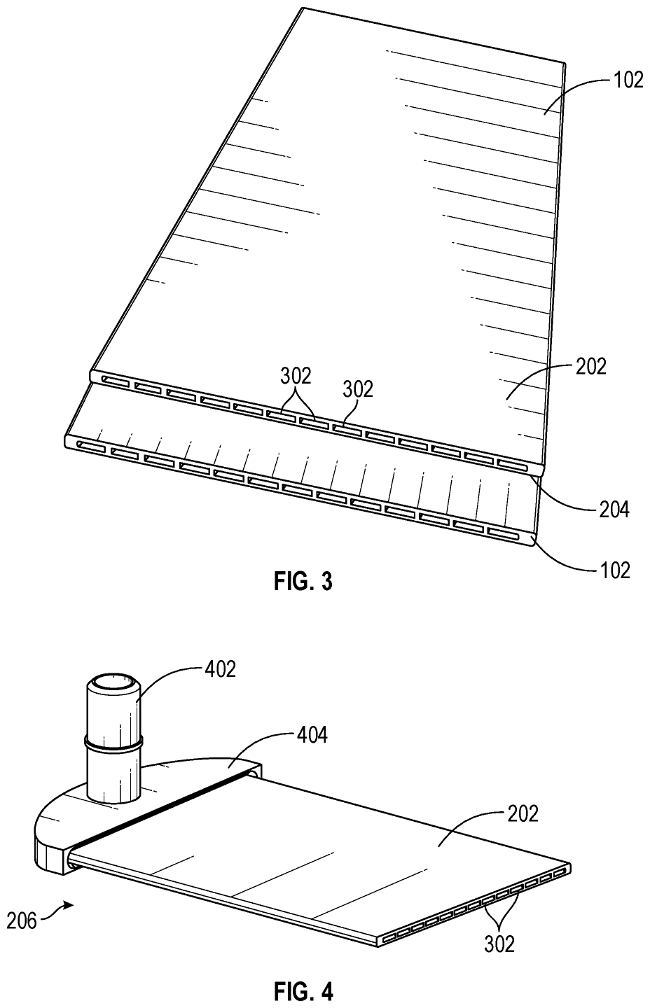

FIG. 3 is a perspective cross-sectional view of two elongated, flattened tubes 102 each having one or more fluidic channels 302 disposed between the first surface 202 and second surface 204 of the respective flattened tube. The one or more fluidic channels 302 are configured to have a thermal transfer fluid (not pictured) disposed therein. As shown in FIG. 3, each of the one or more fluidic channels 302 is substantially rectangular in cross section. The second surface 204 may be equipped with a surface finish (not pictured) configured to radiate thermal energy. FIG. 4 is a perspective view of a fluidic inlet 206 comprising a fluidic coupler 402 and disperser 404. Fluidic coupler 402 is configured to receive a tube or other fluidic transfer means (not pictured) and transmit the thermal transfer fluid from the tube to the disperser 404. Disperser 404 disperses the thermal transfer fluid from the fluidic coupler to the one or more fluidic channels.

Automobiles

Automobiles having a radiator are also disclosed herein. In one aspect, the automobile includes any one of the radiators as described herein.

In some embodiments, the radiator is positioned on an external surface of the automobile such that thermal energy is transmitted by a heat generating component in the automobile through the external surface of the automobile to the radiator. In some embodiments, the heat generating component transmits heat directly to the radiator. In other embodiments, the heat generating component transmits heat to a thermal transfer fluid that subsequently enters the radiator through the fluidic inlet, where heat is subsequently transferred to the radiator by the thermal transfer fluid.

In some embodiments, the radiator is affixed to the external surface of the automobile using a thermal transfer adhesive. The thermal transfer adhesive can be any adhesive known in the art suitable for adhering the radiator to the external surface of the automobile while also facilitating thermal transfer between the radiator and the automobile.

In some embodiments, the radiator is a discrete part that is integrated within the external surface of the automobile such that the thermal energy is transmitted by a heat generating component of the automobile directly to the radiator without passing through the external surface. In other words, the radiator may “replace” a portion of the external surface and operate as a portion of the external surface itself.

In some embodiments, the one or more elongated, flattened tubes of the radiator are integrated within a portion of the external surface of the automobile such that the portion is configured to transmit thermal energy. The radiator may accept thermal energy transmitted by a heat generating component as it is transmitted through the external surface. In other words, the one or more elongated, flattened tubes may be built in to the external surface.

In some embodiments, the radiator is configured to transmit thermal energy from the automobile to external air. In other embodiments, the radiator is configured to transmit thermal energy from external air to the automobile, thereby supplementing a heat output generated by a heater. In some embodiments, multiple radiators as described herein are integrated into the automobile, and each radiator can be configured to transfer heat from the automobile or to the automobile depending on the needs of the automobile and the thermal properties of the environment.

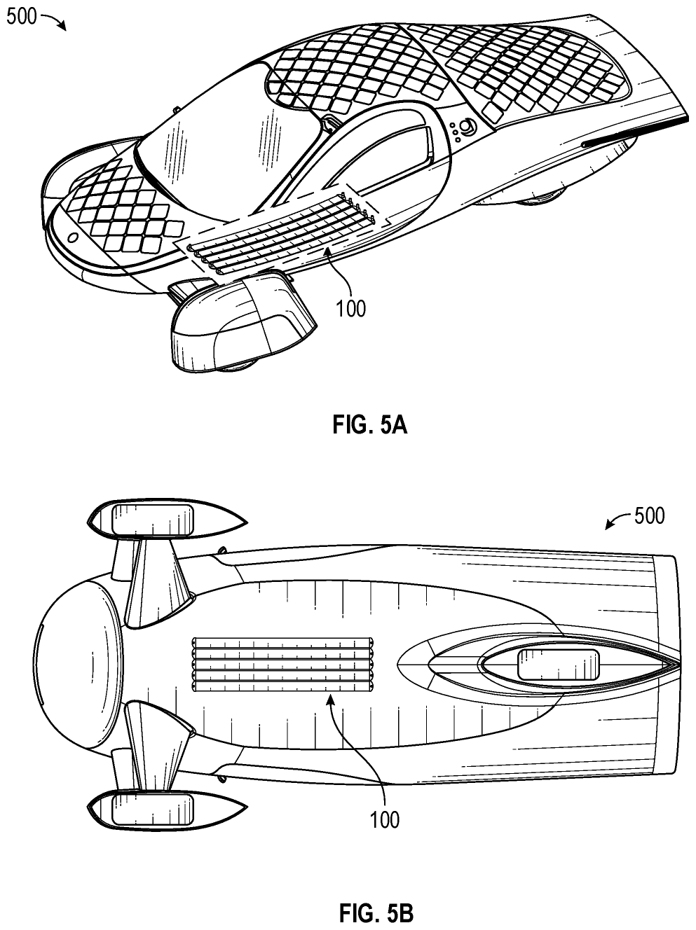

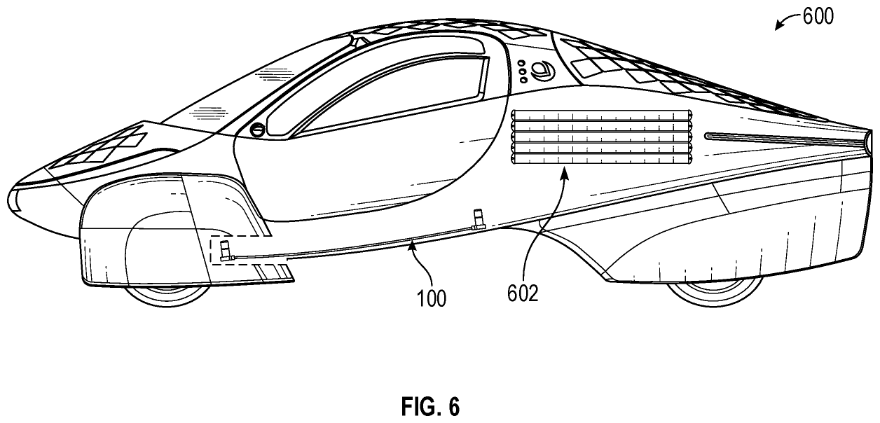

FIGS. 5A and 5B depict an automobile 500 including a radiator 100. FIG. 6 depicts an automobile 600 including a first radiator 100 and a second radiator 602. In some embodiments, the radiator 100 is positioned on an underside of the automobile, as depicted in FIGS. 5A and 5B. In other embodiments, the radiator is positioned on another surface of the automobile, such as the side of the automobile as depicted in FIG. 6. As depicted in FIG. 6, multiple radiators may be positioned on the automobile depending on the needs of the automobile and on the aerodynamics of the automobile. In some embodiments, the automobile has a diffuser or other aerodynamic feature configured to redirect airflow around the automobile chassis and the radiator may be positioned to advantageously maximize airflow based on these aerodynamic features of the automobile.

Although the radiators in FIGS. 1, 5, and 6 are each depicted as having five tubes, more or fewer tubes may be included in the radiator depending on the cooling needs of the automobile, size constraints in a desired installation zone in an automobile, the number of tubes and/or radiators elsewhere in the automobile, etc. For example, a radiator may have 1 tube, 2 tubes, 3 tubes, 4 tubes, 6 tubes, 7 tubes, or more. The tubes in a given radiator assembly may each have different lengths, different widths, and/or different thicknesses. Furthermore, the tubes and radiator may be shaped to conform to the surface of the automobile where the radiator is installed, such as the radiator depicted on the bottom of the automobile in FIG. 6.

Methods of Transferring Thermal Energy to or from an Automobile

Methods of transferring thermal energy to or from an automobile are also described herein. In one aspect, the method includes integrating any radiator as described herein into an external surface of an automobile.

In some embodiments, integrating the radiator into the external surface of the automobile includes affixing the radiator to the external surface. In some embodiments, thermal transfer adhesive is used to affix the radiator. The method may include transmitting thermal energy generated by a heat generating component through the external surface of the automobile to the radiator. In some embodiments, the thermal energy is transmitted directly through the external surface. In other embodiments, the thermal energy is transmitted through the external surface using a thermal transfer fluid.

In some embodiments, integrating the radiator into the external surface of the automobile includes incorporating the radiator as a discrete part into the external surface of the automobile such that thermal energy is transferred directly to the radiator without passing through the external surface.

In some embodiments, integrating the radiator into the external surface of the automobile includes incorporating the one or more elongated, flattened tubes of the radiator within a portion of the external surface of the automobile such that the portion is configured to transmit thermal energy, and wherein thermal energy is transmitted by a heat generating component of the automobile through the portion of the external surface in which the one or more elongated, flattened tubes are incorporated.

Radiators, automobiles, and methods of transferring thermal energy to or form an automobile have been provided. The radiators include one or more elongated, flattened tubes configured to transfer thermal energy to or from the automobile while minimally affecting the automobiles reference area.

While the disclosure has been described with reference to a number of embodiments, it will be understood by those skilled in the art that the disclosure is not limited to such embodiments. Rather, the disclosure can be modified to incorporate any number of variations, alterations, substitutions, or equivalent arrangements not described herein, but which are commensurate with the spirit and scope of the disclosure. Conditional language used herein, such as “can,” “could,” “might,” or “may,” unless specifically stated otherwise, or otherwise understood within the context as used, generally is intended to convey that certain embodiments include, while other embodiments do not include, certain features, elements or functional capabilities. Additionally, while various embodiments of the disclosure have been described, it is to be understood that aspects of the disclosure may include only some of the described embodiments. Accordingly, the disclosure it not to be seen as limited by the foregoing described, but is only limited by the scope of the appended claims.

1. A radiator for transferring thermal energy, the radiator comprising:
one or more elongated, flattened tubes, each tube comprising:
a first surface configured to absorb thermal energy;
a second surface configured to dissipate thermal energy; and
one or more fluidic channels disposed between the first surface and the second surface,
wherein each of the one or more fluidic channels is positioned proximal to the first surface of the tube and the second surface of the tube.

2. The radiator of claim 1, wherein each tube in the one or more elongated, flattened tubes further comprises:
a first fluidic inlet positioned at a first end of the tube;
a second fluidic inlet positioned at a second end of the tube; and
a thermal transfer fluid disposed within the one or more fluidic channels,
wherein the thermal transfer fluid enters the one or more fluidic channels through the first fluidic inlet and exits the one or more channels through the second fluidic inlet, and
wherein the thermal transfer fluid is configured to absorb thermal energy absorbed by the first surface, and transfer the thermal energy to the second surface.

3. The radiator of claim 2, wherein the thermal transfer fluid is water, ethylene glycol, refrigerant, or a combination thereof.

4. The radiator of claim 1, wherein each of the one or more fluidic channels is substantially rectangular in cross section.

5. The radiator of claim 1, wherein the second surface of each tube comprises a surface finish configured to radiate thermal energy.

6. The radiator of claim 5, wherein the surface finish has an emissivity of around 0.95.

7. The radiator of claim 1, wherein the radiator is configured to be positioned on an external surface of an automobile, and wherein the radiator is configured to transfer thermal energy between the automobile and external air.

8. The radiator of claim 7, wherein each tube in the one or more elongated, flattened tubes has a width and a height, and a width:height ratio is from 5:1 to 60:1 such that the radiator is configured to produce less drag than a conventional automobile radiator.

9. The radiator of claim 1, wherein the one or more elongated, flattened tubes comprise aluminum.

10. An automobile comprising one or more radiators, each of the one or more radiators comprising:
one or more elongated, flattened tubes, each tube comprising:
a first surface configured to absorb thermal energy;
a second surface configured to dissipate thermal energy; and
one or more fluidic channels disposed between the first surface and the second surface,
wherein each of the one or more fluidic channels is positioned proximal to the first surface of the tube and the second surface of the tube.

11. The automobile of claim 10, wherein the radiator is positioned on an external surface of the automobile, and wherein thermal energy is transmitted by a heat generating component of the automobile through the external surface of the automobile to the radiator.

12. The automobile of claim 11, wherein the radiator is affixed to the external surface using a thermal transfer adhesive.

13. The automobile of claim 10, wherein the radiator is a discrete part that is integrated within the external surface of the automobile, and wherein thermal energy is transmitted by a heat generating component of the automobile directly to the radiator.

14. The automobile of claim 10, wherein the one or more elongated, flattened tubes of the radiator are incorporated within a portion of the external surface of the automobile such that the portion is configured to transmit thermal energy, and wherein thermal energy is transmitted by a heat generating component of the automobile through the portion of the external surface in which the one or more elongated, flattened tubes are integrated.

15. The automobile of claim 10, wherein the radiator is configured to transmit thermal energy from the automobile to external air.

16. The automobile of claim 10, wherein the radiator is configured to transmit thermal energy from external air to the automobile, thereby supplementing a heat output generated by a heater.

17. A method of transferring thermal energy to or from an automobile, the method comprising:
providing an automobile; and
integrating a radiator into an external surface of the automobile, the radiator comprising:
one or more elongated, flattened tubes, each tube comprising:
a first surface configured to absorb thermal energy;
a second surface configured to dissipate thermal energy; and
one or more fluidic channels disposed between the first surface and the second surface,
wherein each of the one or more fluidic channels is positioned proximal to the first surface of the tube and the second surface of the tube.

18. The method of claim 17, wherein integrating the radiator comprises affixing the radiator to an external surface of the automobile, and wherein thermal energy is transmitted by a heat generating component of the automobile through the external surface of the automobile to the radiator.

19. The method of claim 18, wherein attaching the radiator comprising applying a thermal transfer adhesive to the external surface of the automobile.

20. The method of claim 17, wherein integrating the radiator comprises integrating the radiator as a discrete part within the external surface of the automobile, and wherein thermal energy is transmitted by a heat generating component of the automobile directly to the radiator.
